(19) United States
(12) Patent Application Publication
(10) Pub. No.: US 2012/0211557 A1
(43) Pub. Date: Aug. 23, 2012

(54) Friending Codes

(75) Inventor: Scott C. Harris, Rancho Santa Fe, CA (US)

(73) Assignee: Harris Technology, LLC, Rancho Santa Fe, CA (US)

(21) Appl. No.: 13/400,042

(22) Filed: Feb. 18, 2012

Related U.S. Application Data
(60) Provisional application No. 61/445,188, filed on Feb. 22, 2011.

(51) Int. Cl. G06F 17/00; G06K 19/06

(52) U.S. Cl. 235/375; 235/494

(57) ABSTRACT

Codes that can be used to cause automatic connections with a friend on a social network. In one embodiment, the code can be created by the social network, including information representing the social networks address, and information about the user with whom the connection is desired. In one embodiment, that connection information can create an automatic connection with the user, without requiring the user to accept the “friend request”. The code can be a barcode such as a QR code.

This application claims priority from application No. 61/445188, filed Feb. 22, 2011, the entire contents of which are herewith incorporated by reference.

### BACKGROUND

Social networks can involve friends that you met in the virtual world. Many times your real world friends also become your virtual world friends.

When you meet somebody in the real world, you might tell them your name etc. and social network, e.g., Facebook information, so that they can become your Facebook friends.

### SUMMARY

The present application describes a way of automated friending of new people in a social network based on information that can be provided to another person. According to another embodiment, this can be done using barcodes or other codes that can be sensed/scanned/imaged using a handheld device.

### BRIEF DESCRIPTION OF THE DRAWINGS

The different figures show different embodiments.

FIG. 1 shows the hardware and an overall flow of the system.

### DETAILED DESCRIPTION

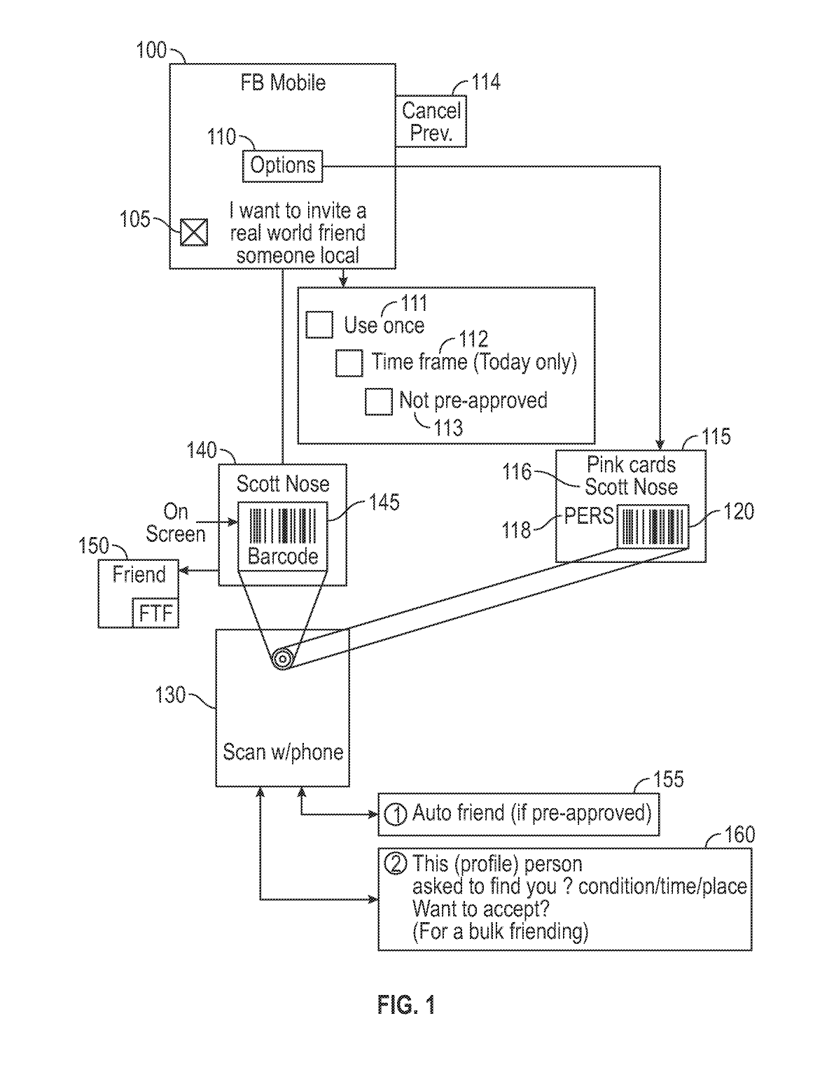

The FIG. 1 shows an embodiment in which the user on a social networking website, here Facebook mobile, indicates a desire to invite or make friends on the social networking site, originating from interactions in from the real world. For example, in the Facebook mobile application shown as 100, there may be a box 105 that is checked to indicate that you (the user) want to invite one or more real world friends. There may be different options shown as 110 which are associated with this real world invite.

The first option shown is the ability to print “cards” 115. For example, these could be a virtual business card, of a conventional type that lists your name 116, other personal information 118 and also has a special code 120. In the embodiment, the code is shown as a barcode of a type that can be imaged by a camera on a phone. For example, the barcode can be a “Semacode” or “QR” type code, optimized for imaging using a cell phone camera.

Other scannable codes can be used. According to another embodiment, the code can be a unique alphanumeric code that can be entered by a user, or imaged using the camera on a cellphone. This code 120 may represent a preapproved friend request according to one embodiment. For example, a user may print a number of cards, which preapprove anyone who has these unique codes on the cards, to be their friend. A user can give these cards out to people. The code is for a preapproved friend connection, where you have already approved the friending and hence do not need to approve it again. Hence, anyone the user gives this card to, can become their friend using the information on the card, without their approving the request again.

This is an automatically preapproved friend request card in one embodiment.

Different embodiments may allow the codes on the card to be used in different ways.

In one embodiment, the code 120 in this embodiment may be usable only once if the use once option 111 is checked.

Another option 112 may specify the time frame in which the code may be usable, for example only February 1 through February 7. The code may become unusable after that date.

Another option, which may be the default option when the use once box 111 is not checked, is that the friends are not preapproved. For example, when the use once box is checked, each of the cards 115 will be unique and can be used only once, and when used, create an automatic friend relationship. These cards are given only to people the user meets in the real world, who can then become your friend, without approval, when used.

There is also a “not preapproved” box 113, that is used when the cards are not preapproved.

When the box 111 is not checked, these codes can be used as long as they are valid, where the time frame (which might default to one month, or one year) can be set by option 112.

Another option shown as 114 may be the option to cancel a previously given card. For example, if the user gives a card to someone and later changes their mind, the user may be able to cancel any preapproval that has been associated with that card.

The card 115 may be given out to people, and any user may then or later scan that card with their phones 130 using the camera in the phone, using the techniques described in for example my co-pending application U.S. Pat. No. 6,666,377 or using Semacode or QR code techniques.

Another option from the mobile application is to display the invite on the screen of the user's mobile device, shown as 140. For example, 140 is shown displaying the barcode 145 on the screen, where the barcode is a use-once barcode and represents a preapproved invite to be a friend on a social network. On the screen may also be displayed information about the person and the friending circumstance. For example, the location of the phone and date and time may be either displayed or maintained so that the social network receives the information that you friended this person at a specific event that occurred at the location, date and time where the friending occurs.

This same technique may be used on the printed cards 115. A user can print the printed cards for a special event. For example, cards can be printed , for example the 2010 new year's eve rave at Bob's house. When the user friends on social network, the friend will automatically show the user that this is someone you met at the 2010 Rave at Bob's house., so that you know you are automatically where you met this person.

The codes can also be generated and added to documents (e.g., printed or mailed or emailed documents) or to emails. A user can scan the code in the email to become a Facebook friend or to be connected on some other site.

One application of this is a user can go to a meeting where a user meets a number of people. Very often people who meet each other in this way exchange business cards, and discuss various things. In this embodiment, a user's business card that a user give out can include a special code that can be scanned by the user to allow them to add a user as a social network friend.

In another embodiment, the friending will automatically indicate when a user met the person and where. The location of where can be automatically determined by the personal communicator that is doing the scanning, based on the current location and date. An alternative is that the code can include a user's current whereabouts at the time of creating the code—e.g., the textual information such as “patent meeting 2010”.

The above has described printing cards, but it should be understood that the codes can be added to existing cards e.g. by printing on the existing cards or by stickers for any other technique. Also, the same techniques can be used for the electronic code.

Another embodiment labels friends differently when they are met through automatic face-to-face interaction. That friended person may then be labeled separately as an FTF friend. This may make some friends different than other friends. Any friend that a user knows FTF after can be marked as such at as shown at 150. This provides that friend with a certain degree of trust.

Since a user met these people, a user knows that these are people are real, that is, not someone masquerading as someone else, and hence the measure of FTF friends may be used by a user (or by someone else) as a measure of trust and/or security on the social network.

The options at 110 can include, as noted above, an option to auto friend shown as 155. These auto friends are intended to be given only to people who a user preapproves as to be their friend. That person entering the code or scanning the barcode may later automatically be friended on a social network without your approval.

A second format at 160 indicates that this person will need to get your approval, but does so only based on the information a user already know about the person. 160 shows how this code is key to an event, so that a user get a friend request that says “this (person's profile here e.g. name etc.) person has asked a friend a user based on (the event that occurred at condition, time, date, place ( ). Do a user want to accept?

When the code is read, the social network site can automatically determine profile information about the reader from information in the portable communicator. As an alternative, the reader may need to either be logged on at the time of scanning the optical code, or to enter their login information after scanning the optical code.

Another advantage of this system is its ability to allow creating social networks from real world people. For example, a person can appear at a tradeshow, or go to a professional organization such as the convention or a job fair. While at that professional organization, the user can print scannable barcodes either on a business card, or on a sign for example that is used at a booth where anyone can see the sign. Users can scan the QR code on the sign, using their scanning application, which can provide for example the URL that brings them to a specified sub page on the social network. As an alternative, this can be a dynamic QR code, which brings the user to a dynamic page that is itself redirected to a specified sub page on the Internet or fills in certain information on a page on the Internet. The code on the sign can allow any different person who visits the booth to either friend the user at the booth, or join a specified “group”. For example, this could be used to join a group within a professional social network such as Linkedln, to join the group, or to join the special group, such as “people interested in jobs at ABC Corporation”.

The barcode can include a number of different pieces of information encoded therein, including the name of the site, the users name for whom the friend is requested, and, optionally, a code that allows either automatic friending, or may allow some other action on the website (such as signaling that the source of this friend was a face-to-face meeting, as described above).

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

For example other information can be displayed on these screens, including alphanumeric information. Other kinds of networks that allow user connections can be accessed in this way. The above has described the optically readable code as being barcode, however any optically readable code can be used in this way. For example, the social network site may provide the barcode information to the user along with an ability to create that barcode, either as an image for use in an e-mail, and/or in a form that can be printed on paper or printed on a sign. For example, the social networking site may have an application that allows this.

The codes can be relayed by other devices, including by giving out memory media, such as CDs/USB flash drives/RFID devices, or the like. This can provide, for example, a preapproved friend request as part of a product . In this embodiment, the company may sell a product, for example a T-shirt. That T-shirt may include a preapproved friend request to become a friend on the social network of the company that is selling the teacher. By becoming an “friend” of that company on the social network, the user may obtain some prize or other advantage on the social network. The user can use either the code described above, or the CD or USB code to become the friend.

Certain kinds of computers are disclosed, but other computers, both server and client, are contemplated to be within this disclosure.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCl”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

At least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein. The computer system can be a network-connected server with a communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of communicating with a website , comprising:
a portable communicator device reading an optically readable code and determining information from said optically readable code indicative of a website, and a specific person or group to be added on said website; and
sending, from the portable communicator device, information from the optically readable code to the website;
said information representing said specific person or group to be added on the website.

2. The method as in claim 1, wherein said website is a social networking site of a type that allows connections between users of the website.

3. The method as in claim 2, wherein said specific person or group is a person to be added as a friend and further comprising showing, on the portable communication device, that said specific person or group has been added as a friend subsequent to said sending.

4. The method as in claim 2, wherein said information from said optically readable code includes information which causes automatic acceptance of a friend on the social network site, and further comprising showing, on the portable communication device, that said friend has been accepted subsequent to said sending.

5. The method as in claim 1, wherein said portable communicator device reading said optically readable code which is a barcode.

6. A method of operating a social network website, comprising:
storing plural different user profiles representing plural different users on a social network website, and also storing connections between said users on said social network website;
allowing users to access the website, to obtain information from said website, and to create additional connections on said website, wherein said create additional connections on said website requires a second user to request a connection with a first user, and then requires said first user to accept said connection before said first and second users have said connection; and
providing information for an optically readable code to said first user, which automatically, when optically read, causes a reader of the code to form a connection on said website with the first user.

7. The method as in claim 6, wherein said reader is added as a friend on said website and further comprising adding said reader as a friend subsequent to said optically-readable code being read.

8. The method as in claim 7, wherein said information from said optically readable code includes information which causes automatic acceptance of the friend on the social network website without further action by the first user.

9. The method as in claim 6, wherein said information provided by said social network is a barcode which includes information including at least website information, and information usable on said website, and where said information includes information sufficient to form a connection on said website.

10. The method as in claim 6, wherein said information provided by said social network is a barcode, which when scanned, provides information causing automatic connection of a friend on the social network, without further action by the first user.

11. A social network website, comprising:
a server computer running a website that is accessible over a network, said website storing plural different user profiles representing plural different users and also storing connections between said users on said social network website;
said server computer allowing users allowing users to obtain information from said website, and to form additional connections on said website, wherein said form additional connections on said website requires a second user to request a connection with a first user, and then requires said first user to accept said connection before said first and second users form said connection;
said server computer providing information about an optically readable code to said first user, which automatically, when optically read, causes a reader of the code to form a connection on said website with the first user.

12. The website as in claim 11, wherein said optically readable code is a barcode.

13. The website as in claim 12, wherein said barcode includes information indicative of a web address of said website, and also information indicative of said first user.

14. The website as in claim 12, wherein said information indicative of said first user includes information indicative of an automatic acceptance, but does not require said first user to accept said connection prior to making said connection.

15. The website as in claim 11, wherein said connection is a friend request.

16. The website as in claim 15, wherein said information from said optically readable code includes information which causes automatic acceptance of the friend on the social network website without further action by the first user.

17. The website as in claim 11, wherein said information provided by said social network is a barcode, which when scanned, provides information causing automatic connection of a friend on the social network, without further action by the first user.

18. The website as in claim 17, wherein said barcode is provided in a form to be printed.

19. The website as in claim 17, wherein said barcode is provided in a form to be included within an electronic communication such as an e-mail.

20. A barcode, having information therein indicative of a social networking website, and information indicative of a first person to be friended on said social networking site, and including information which, when scanned by remote device, causes an automatic friending of said first person on said website without any action taken by said first person.
